(19) United States
(12) Patent Application Publication
(10) Pub. No.: US 2019/0356794 A1
(43) Pub. Date: Nov. 21, 2019

(54) IMAGE PROCESSING APPARATUS, IMAGE FORMING APPARATUS, IMAGE PROCESSING METHOD, AND STORAGE MEDIUM HAVING IMAGE PROCESSING PROGRAM STORED THEREIN

(71) Applicant: SHARP KABUSHIKI KAISHA, Sakai City (JP)

(72) Inventor: SATOSHI TAKAHASHI, Sakai City (JP)

(21) Appl. No.: 16/409,694

(22) Filed: May 10, 2019

(30) Foreign Application Priority Data
May 18, 2018 (JP) 2018-096349

(51) Int. Cl. H04N 1/00

(52) U.S. Cl. CPC H04N 1/00225; H04N 1/00482

(57) ABSTRACT

An image processing apparatus includes: an image data acquiring unit allowing input of image data from outside; an operation unit receiving a transmission instruction indicating that an electronic mail including address information allowing access to the image data input from the image data acquiring unit is to be transmitted to an external device; an integrated image data generation unit generating, in a case where a plurality of pieces of image data are input from the image data acquiring unit and the operation unit receives the transmission instruction for the plurality of pieces of image data, when a predetermined integration condition is satisfied, integrated image data in which the plurality of pieces of image data are combined into one file and saves it in a predetermined location; and a communication unit transmitting, to the external device, an electronic mail including address information allowing access to the integrated image data.

### BACKGROUND

### 1. Field

The present disclosure relates to an image processing apparatus, an image forming apparatus, an image processing method, and a storage medium having an image processing program stored therein.

### 2. Description of the Related Art

A technique of the related art for, in transmitting an image to a receiving party via an electronic mail, instead of directly attaching the image to the electronic mail for transmission, uploading image data to a predetermined storage apparatus such as a server and describing link information (such as a URL) of the image data in the electronic mail for transmission has been known.

The technique has such an advantage that the receiving party is able to access the image data by clicking the URL described in the electronic mail, and therefore, even when the image data has a large size, the receiving party is able to transmit the image data without caring about restriction of a communication traffic volume.

As a disclosure related to such transmission of image data, a disclosure in which two kinds of image files of a display image file and a high-quality file are created for image data that is input and a receiver of an electronic mail who has confirmed the display image displayed on a terminal of the receiver requests transfer of the high-quality image is disclosed (for example, refer to Japanese Unexamined Patent Application Publication No. 10-233860).

In a case of transmitting a plurality of pieces of image data, however, the receiver of the electronic mail is requested to click link information of the pieces of image data one by one, and thus an operation is complicated.

The disclosure is made in view of circumstances described above, and provides an image processing apparatus, an image forming apparatus, an image processing method, and a storage medium having an image processing program stored therein that allow, when link information of a plurality of pieces of image data is transmitted via an electronic mail, a receiver to easily refer to the plurality of pieces of image data and that have high convenience.

### SUMMARY

The disclosure provides an image processing apparatus including: an image data acquiring unit that acquires image data from outside; an operation unit that receives a transmission instruction indicating that an electronic mail including address information which allows access to the image data acquired by the image data acquiring unit is to be transmitted to an external device; an integrated image data generation unit that, in a case where the image data acquiring unit acquires a plurality of pieces of image data and the operation unit receives the transmission instruction for the plurality of pieces of image data, when an integration condition that is predetermined is satisfied, generates integrated image data in which the plurality of pieces of image data are combined into one file and saves the integrated image data in a predetermined location; and a communication unit that transmits, to the external device, an electronic mail including address information which allows access to the integrated image data.

Moreover, the disclosure provides an image forming apparatus including: the image processing apparatus; and an image forming unit that forms an image based on image data processed by the image processing apparatus.

Moreover, the disclosure provides an image processing method including: acquiring image data from outside; receiving a transmission instruction indicating that an electronic mail including address information which allows access to the image data acquired in the acquiring is to be transmitted to an external device; generating, in a case where a plurality of pieces of image data are acquired in the acquiring and the transmission instruction for the plurality of pieces of image data is received in the receiving, when an integration condition that is predetermined is satisfied, integrated image data in which the plurality of pieces of image data are combined into one file and saving the integrated image data in a predetermined location; and transmitting, to the external device, an electronic mail including address information which allows access to the integrated image data.

Moreover, the disclosure provides a storage medium storing an image processing program causing a processor of an image processing apparatus to execute: acquiring image data from outside; receiving a transmission instruction indicating that an electronic mail including address information which allows access to the image data received in the acquiring is to be transmitted to an external device; generating, in a case where a plurality of pieces of image data are acquired in the acquiring and the transmission instruction for the plurality of pieces of image data is received in the receiving, when an integration condition that is predetermined is satisfied, integrated image data in which the plurality of pieces of image data are combined into one file and saving the integrated image data in a predetermined location; and transmitting, to the external device, an electronic mail including address information which allows access to the integrated image data.

In the disclosure, the “image processing apparatus” is an apparatus that has a function of saving image data, which is acquired form outside, in a predetermined location and transmitting, to an external device, an electronic mail including address information that allows access to the image data.

The “image data acquiring unit” is a unit that has an image reading function, such as a scanner function, of generating image data of a predetermined file format (such as JPEG, PNG, or PDF), for example, by reading an original document.

The image data acquiring unit may receive image data acquired via a network, a USB, or the like.

The “predetermined location” may be, for example, a shared folder which is in the image processing apparatus and allows access from outside, a server outside the image processing apparatus, or the like.

The “image forming apparatus” is an apparatus that has an image data input function of allowing input of image data, an electronic mail transmission function of transmitting an electronic mail to an external device, and an image forming function of forming and outputting an image on the basis of the image data, and an example thereof includes a multifunction peripheral having a scanner function and an electronic mail transmission function.

The “image data acquiring unit” of the disclosure is realized by an image acquiring unit 11 and the “integrated image data generation unit” of the disclosure is realized by an image processing unit 14.

### BRIEF DESCRIPTION OF THE DRAWINGS

FIG. 1 is a perspective view illustrating an exterior of a digital multifunction peripheral according to Embodiment 1 of the disclosure;

FIG. 2 is a block diagram illustrating a schematic configuration of the digital multifunction peripheral illustrated in FIG. 1;

FIG. 3 illustrates an example of notification of image link information by an electronic mail generated by a digital multifunction peripheral of the related art;

FIG. 4 is a flowchart illustrating an example of a flow of job setting processing of the digital multifunction peripheral illustrated in FIG. 1;

FIG. 5 is an explanatory view illustrating an example of a screen of a display unit of the digital multifunction peripheral illustrated in FIG. 1;

FIG. 6 is an explanatory view illustrating an example of a screen of the display unit of the digital multifunction peripheral illustrated in FIG. 1;

FIG. 7 is an explanatory view illustrating an example of a screen of the display unit of the digital multifunction peripheral illustrated in FIG. 1;

FIG. 8 is an explanatory view illustrating an example of a screen of the display unit of the digital multifunction peripheral illustrated in FIG. 1;

FIG. 9 is an explanatory view illustrating an example of a screen of the display unit of the digital multifunction peripheral illustrated in FIG. 1;

FIG. 10 is an explanatory view illustrating an example of a screen of the display unit of the digital multifunction peripheral illustrated in FIG. 1;

FIG. 11 is a flowchart illustrating an example of a flow of lob setting processing of a digital multifunction peripheral according to Embodiment 2 of the disclosure;

FIG. 12 is an explanatory view illustrating an example of a setting screen of an image link information notification function of the digital multifunction peripheral illustrated in FIG. 11;

FIG. 13 is a flowchart illustrating an example of a flow of job setting processing of a digital multifunction peripheral according to Embodiment 3 of the disclosure;

FIG. 14 is an explanatory view illustrating an example of a setting screen of the image link information notification function of the digital multifunction peripheral illustrated in FIG. 13; and

FIG. 15 illustrates an example of notification of image link information by an electronic mail transmitted by the digital multifunction peripheral illustrated in FIG. 13.

### DESCRIPTION OF THE EMBODIMENTS

The disclosure will be described below in more detail with reference to drawings.

Note that, the following description is merely an example in all respects and should not be deemed to limit the disclosure.

### Embodiment 1

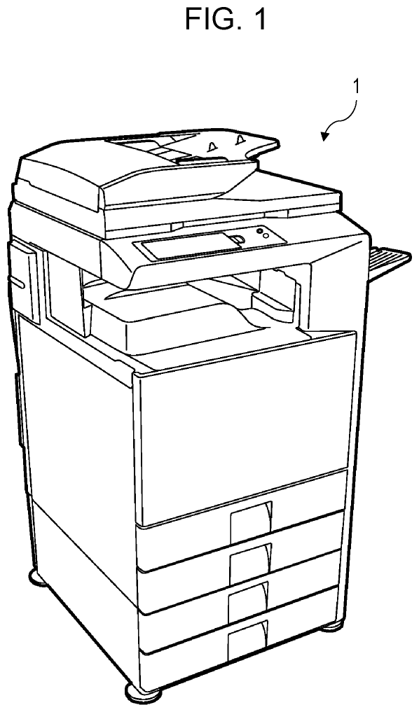

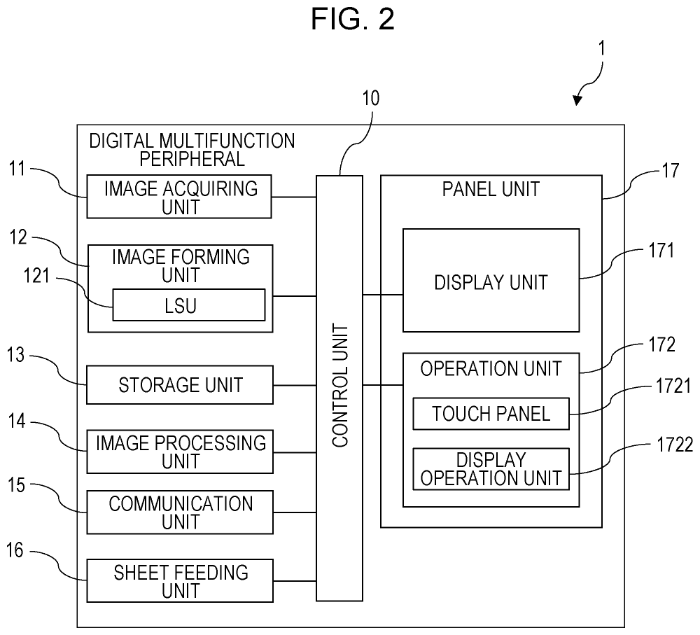

A digital multifunction peripheral 1 that is an embodiment, of an image forming apparatus of the disclosure will be described with reference to FIGS. 1 and 2.

FIG. 1 is a perspective view illustrating an exterior of the digital multifunction peripheral 1 according to Embodiment 1 of the disclosure FIG. 2 is a block diagram illustrating a schematic configuration of the digital multifunction peripheral 1 illustrated in FIG. 1.

Note that, the disclosure is not limited to the digital multifunction peripheral 1 and is applicable to all devices having an image reading function and an electronic mail transmission function.

The digital multifunction peripheral 1 is an apparatus such as an MFP (Multifunction Peripheral) that performs digital processing of image data and has a copy function, a scanner function, and a facsimile function.

The digital multifunction peripheral 1 executes a job of scan, printing, copy, image transmission (Scan to Email, Scan to Ftp), or the like on the basis of an instruction that is given by a user and received via an operation unit 172 or a communication unit 15.

As illustrated in FIG. 2, the digital multifunction peripheral 1 includes a control unit 10, an image acquiring unit 11, an image forming unit 12, a storage unit 13, an image processing unit 14, the communication unit 15, a sheet feeding unit 16, and a panel unit 17.

Components of the digital multifunction peripheral 1 will be described below.

The control unit 10 controls the digital multifunction peripheral 1 in an integrated manner and is constituted by a CPU, a RAM, a ROM, various interface circuits, and the like.

To control an overall operation of the digital multifunction peripheral 1, the control unit 10 performs detection of each sensor and performs monitoring and control of all loads on a motor, a clutch, the panel unit 17, and the like.

The image acquiring unit 11 is a unit that detects and reads an original document placed on an original document platen or an original document conveyed from an original document tray and generates image data, and is also a unit that acquires image data generated by an external information processing apparatus (not illustrated), a facsimile apparatus (not illustrated), or the like.

Note that, when acquiring image data from an external information processing apparatus or the like, the image acquiring unit 11 may acquire the image data via a wired or wireless network, acquire the image data recorded in a USB or the like, or acquire the image data by a combined method thereof.

The image forming unit 12 is a unit that prints and outputs image data, which is generated by the image processing unit 14, onto a sheet and includes an LSU 121.

The LSU 121 is a device that irradiates a surface of a photosensitive drum in a charged state with laser light corresponding to image information constituted by a digital signal acquired by the image acquiring unit 11 and forms an electrostatic latent image.

The storage unit 13 is an element or a storage medium in which information, a control program, and the like that are used to implement various functions of the digital multifunction peripheral 1 are stored. For example, a semiconductor element such as a RAM or a ROM, or a storage medium such as a hard disk, a flash memory unit, or an SSD is used.

Note that, a program and data may be retained in different devices in such a manner that a region in which the data is retained is a hard disk drive and a region in which the program is retained is a flash memory unit.

In the disclosure, the image data generated by the image acquiring unit 11 is saved in the storage unit 13, and when an external terminal accesses the image data via the communication unit 15, the image data is downloaded to the external terminal.

The image processing unit 14 is a unit that converts an image of an original document read by the image acquiring unit 11 into an appropriate electric signal to generate image data, and performs processing of enlargement, reduction, or the like of the image data, which is input from the image acquiring unit 11, so that an output satisfies an instruction via the operation unit 172.

Moreover, the image processing unit 14 is also a unit that performs processing of generating integrated image data in which a plurality of pieces of image data are combined into one file of a PDF, a TIFF, or the like.

The communication unit 15 is a unit that communicates with a computer, a mobile information terminal, an external information processing apparatus, a facsimile apparatus, or the like via a network or the like and transmits or receives various kinds of information, such as an electronic mail and a FAX, to or from such external communication apparatuses.

The sheet feeding unit 16 is a unit that conveys a sheet stored in a sheet feed cassette or a manual feed tray to the image forming unit 12.

The panel unit 17 includes a display unit 171 and the operation unit 172.

The display unit 171 is a unit that displays various kinds of information. The display unit 171 is constituted by, for example, a CRT display, a liquid crystal display, an EL display, or the like and is a display device, such as a monitor or a line display, which allows an operating system or application software to display electronic data such as a processing state. The control unit 10 causes the display unit 171 to perform display related to an operation and a condition of the digital multifunction peripheral 1.

The operation unit 172 includes a touch panel 1721 and a display operation unit 1722 and is a unit that receives an instruction from the user.

### <Example of Notification of Image Link Information of Related Art>

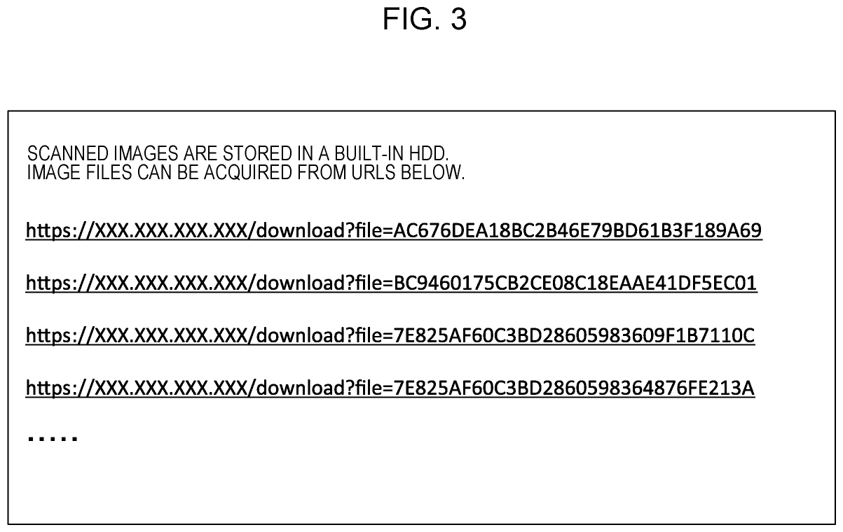

Next, an example of notification of image link. information by an electronic mail generated by a digital multifunction peripheral 2 of the related art is indicated with reference to FIG. 3.

FIG. 3 illustrates an example of notification of image link information by an electronic mail generated by the digital multifunction peripheral 2 of the related art.

In a case where link information of a plurality of pieces of image data is notified via an electronic mail by the digital multifunction peripheral 2 of the related art, URLs of links to a plurality of images are displayed with a message of “Scanned images are stored in a built-in HDD. Image files can be acquired from URLs below.” as illustrated in FIG. 3.

In order to obtain all the image data, a user is requested to click the URLs one by one for downloading, and an operation is complicated.

Thus, in the disclosure, by performing job setting processing as described below, complexity in downloading the plurality of pieces of image data is avoided.

### <Job Setting Processing>

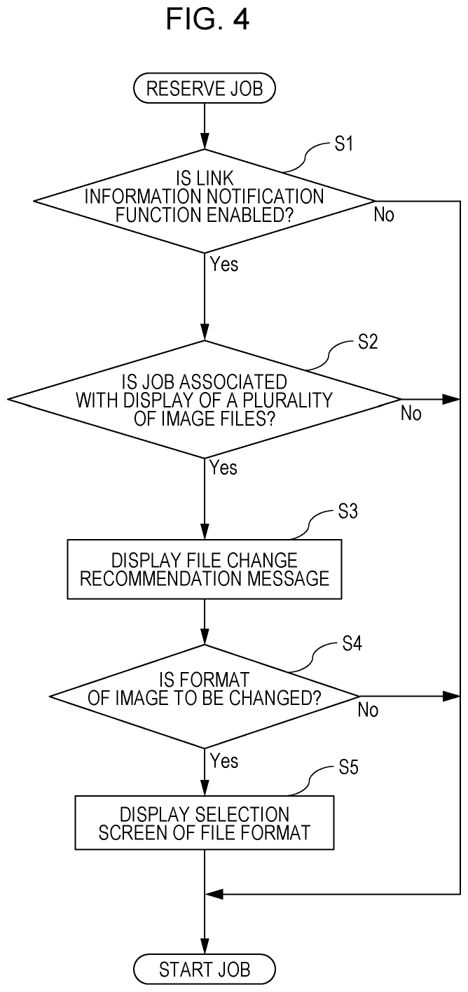

Next, job setting processing according to Embodiment 1 of the disclosure will be described with reference to FIGS. 4 to 10.

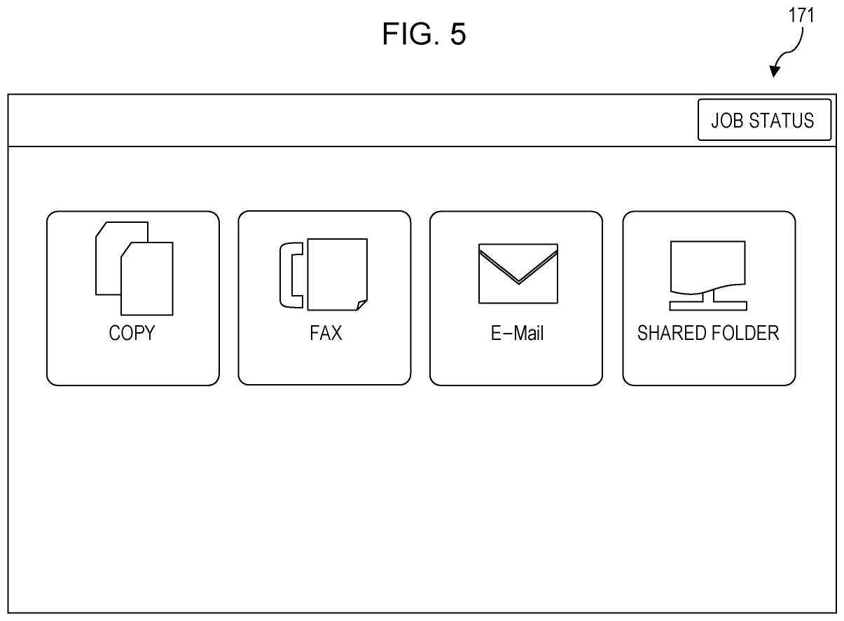

FIG. 4 is a flowchart illustrating an example of a flow of the job setting processing of the digital multifunction peripheral 1 illustrated in FIG. 1. FIGS. 5 to 10 are explanatory views each illustrating an example of a screen of the display unit 171 of the digital multifunction peripheral 1 illustrated in FIG. 1.

In FIG. 4, first, a user reserves a job in accordance with a procedure set in advance.

Specifically, the user selects any job as illustrated in FIG. 5.

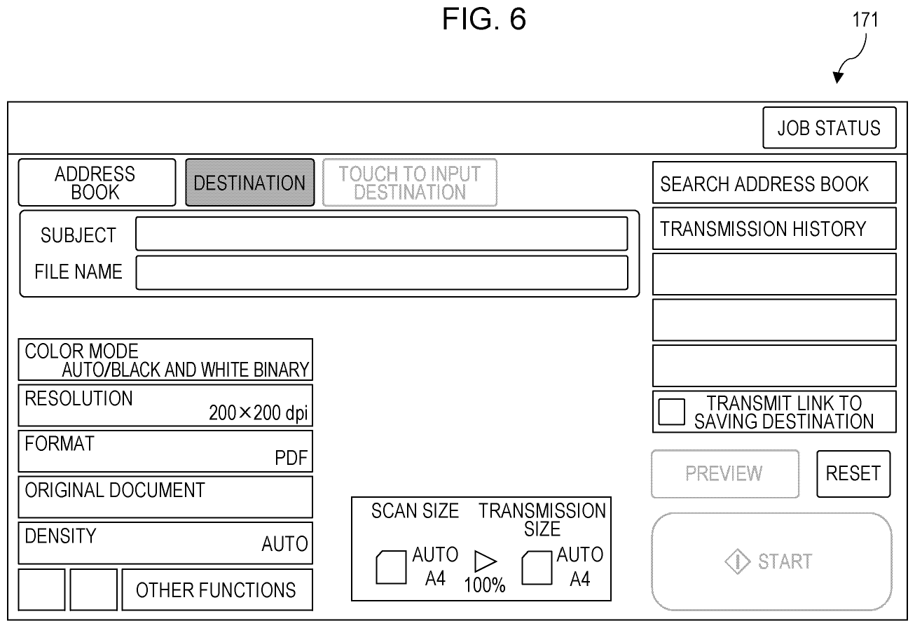

In FIG. 5, when an e-mail is selected as a reserved job, a screen as illustrated in FIG. 6 is displayed.

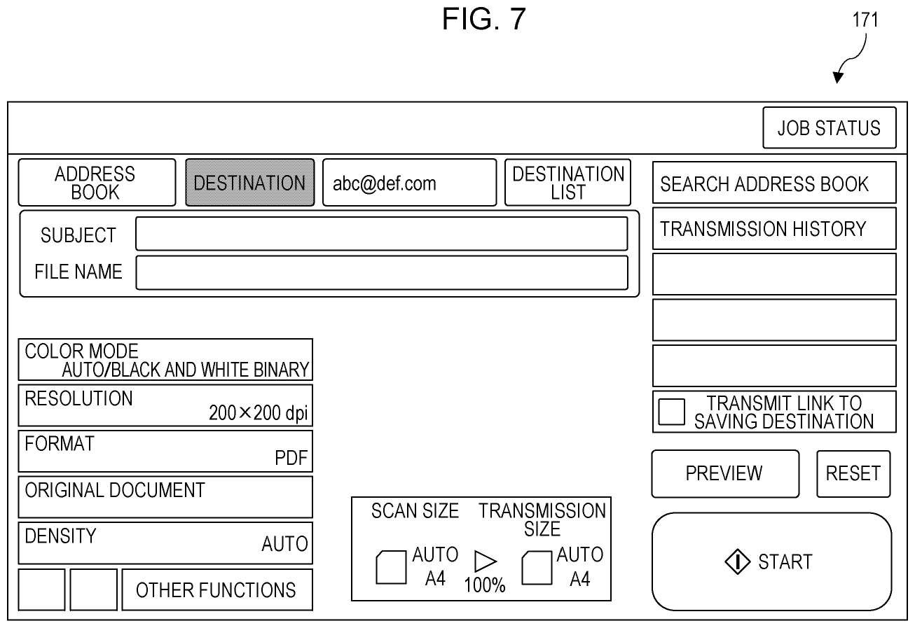

Next, as illustrated in FIG. 7, the user selects a destination from an address book or a communication history or directly inputs a destination to a destination section.

To the destination section of FIG. 7 “abc@def.com” is input.

Next, as indicated in step S1 of FIG. 4, after receiving the job reservation, the control unit 10 determines whether or not a link information notification function is enabled (step S1).

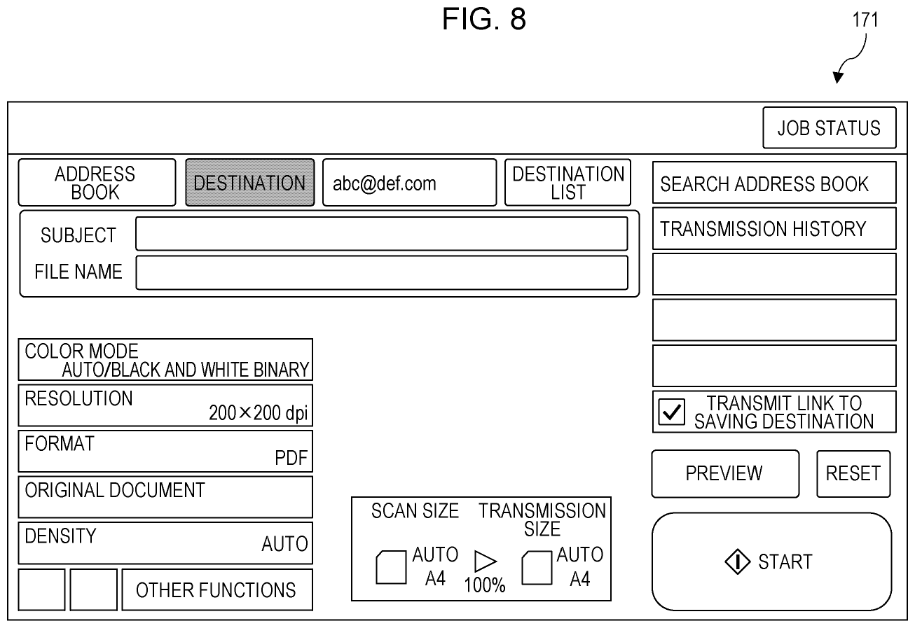

Specifically, as illustrated in FIG. 8, the user checks a checkbox of “transmit link to saving destination” and performs setting of the link information notification function.

By checking the checkbox, a link to a saving destination of image data is transmitted to the destination “abc@def.com” via an electronic mail.

When the link information notification function is enabled at step S1 of FIG. 4 (when Yes is given in the determination of step S1), the control unit 10 performs determination of step S2 (step S2).

On the other hand, when the link information notification function is not enabled (when No is given in the determination of step S1), the control unit 10 starts the job on the basis of a reserved content.

Next, at step S2, the control unit 10 determines whether or not the reserved job is a job associated with display of a plurality of image files (step S2).

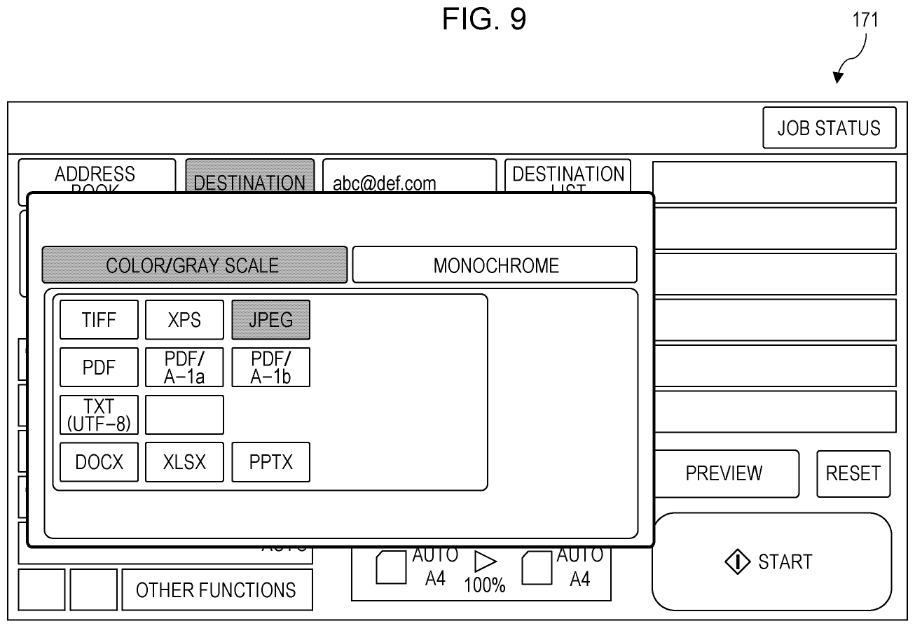

Specifically, as illustrated in FIG. 9, the user selects a format of an image.

FIG. 9, a “JPEG” image is selected as the format of the image.

When the user transmits two or more images, after the first image is selected, similar setting is also performed for the second image.

When the reserved job is a job associated with display of a plurality of image files at step S2 (when Yes is given in the determination of step S2), the control unit 10 performs processing of step S3 (step S3).

On the other hand, when the reserved job is not a job associated with display of a plurality of image files (when No is given in the determination of step S2), the control unit 10 starts the job on the basis of the reserved content.

Next, at step S3, the control unit 10 causes the display unit 171 to display a file change recommendation message (step 33).

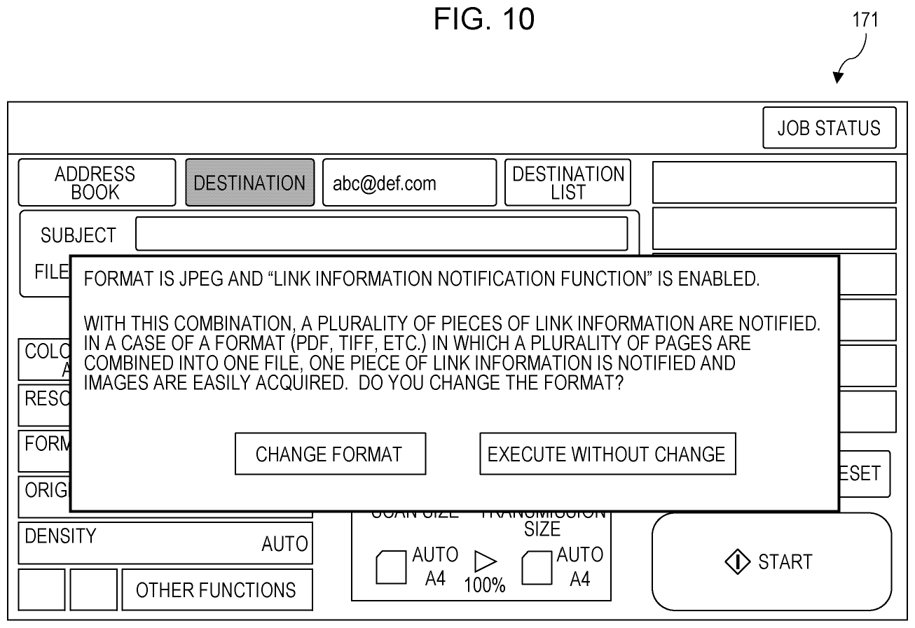

Specifically, the file change recommendation message as illustrated in FIG. 10 is displayed.

In FIG. 10, two icons of “change format” and “execute without change” are displayed with a message of “Format is JPEG and “link information notification function” is enabled. With this combination, a plurality of pieces of link information are notified. In a case of a format (PDF, TIFF, etc.) in which a plurality of pages are combined into one file, one piece of link information is notified and images are easily acquired. Do you change the format?”.

Note that, the file change recommendation message may be displayed after a start button is operated.

Next, at step S4 of FIG. 4, the control unit 10 determines whether or not the format of the image is to be changed (step S4).

Specifically, in FIG. 10, whether the icon of the “change format” or the “execute without change” is selected is determined.

When the format of the image is to be changed (when Yes is given in the determination of step S4), the control unit 10 displays a selection screen of a file format at step S5 (step S5).

Specifically, the user selects a format, such as a PDF or a TIFF, in which images of a plurality of pages are combined into one file.

On the other hand, when the format of the image is not to be changed (when No is given in the determination of step S4), the control unit 10 starts the lob on the basis of the reserved content.

In this manner, in a case where link information of a plurality of pieces of image data is transmitted via an electronic mail, when a format in which images of a plurality of pages are combined into one file is selected, only a link of the images in the one file is displayed for a transmission destination, so that an image forming apparatus that allows a receiver to easily refer to the plurality of pieces of image data and has high convenience is able to be implemented.

It is possible to provide image data so as to be operated more easily, in particular, for a case where the user creates a plurality of pieces of link information of image files without intention or a case where the user does not suppose that downloading of a plurality of image files is complicated.

### Embodiment 2

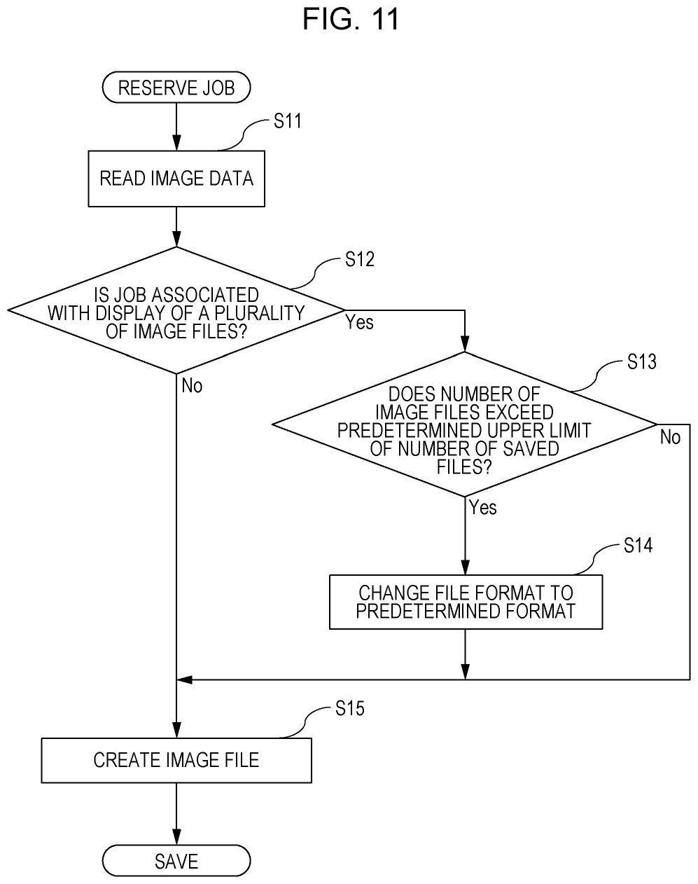

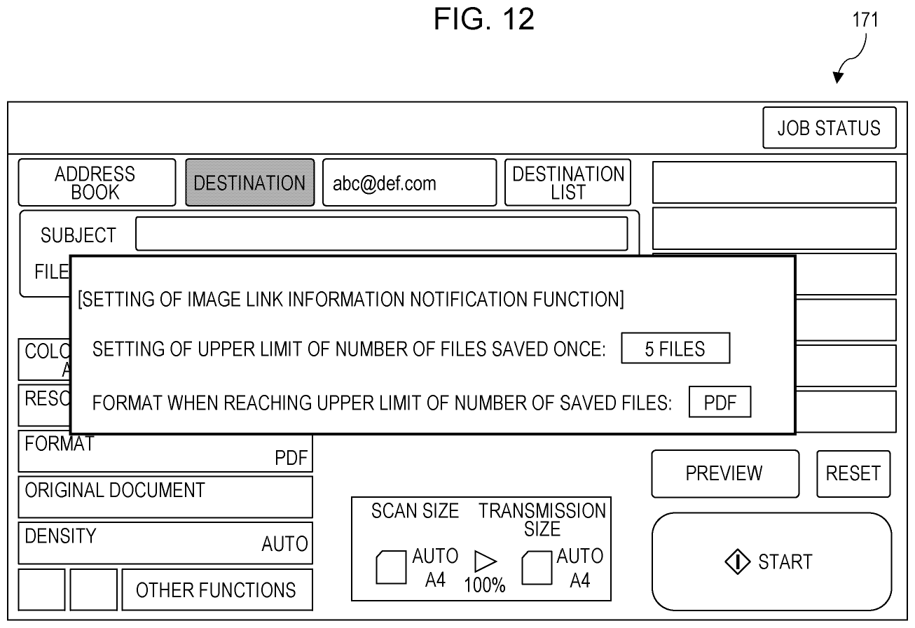

Next, job setting processing of a digital multifunction peripheral 1 according to Embodiment 2 of the disclosure will be described with reference to FIGS. 11 and 12.

FIG. 11 is a flowchart illustrating an example of a flow of the job setting processing of the digital multifunction peripheral 1 according to Embodiment 2 of the disclosure. FIG. 12 is an explanatory view illustrating an example of a setting screen of an image link information notification function of the digital multifunction peripheral 1 illustrated in FIG. 11.

Note that, a schematic configuration of the digital multifunction peripheral 1 according to Embodiment 2 of the disclosure is the same as that in FIG. 2, so that description thereof will be omitted.

In FIG. 11, when the user reserves a job, the control unit 10 causes the image acquiring unit 11 to read image data related to the job reservation at step S11 (step S11).

Next, at step S12, the control unit 10 determines whether or not the reserved job is a job associated with display of a plurality of image files (step S12).

When the reserved job is a job associated with display of a plurality of image files (when Yes is given in the determination of step S12), the control unit 10 performs determination of step S13 (step S13).

On the other hand, when the reserved job is not a job associated with display of a plurality of image files (when No is given in the determination of step S12), the control unit 10 creates an image file at step S15 (step S15) and saves the created image file in the storage unit 13.

Next, at step S13, the control unit 10 determines whether the number of the image files related to the reserved job exceeds a predetermined upper limit of the number of saved files (step S13).

As illustrated in FIG. 12, the user is able to set the upper limit of the number of files saved once in setting of the image link information notification function.

In the example of FIG. 12, the upper limit of the number of files saved once is set to “5 files” and a format when reaching the upper limit of the number of saved files is set to a “PDF”.

When the number of the image files related to the reserved job exceeds the predetermined upper limit of the number of saved files in the determination of step S13 of FIG. 11 (when Yes is given in the determination of step S13), the control unit 10 changes a file format of an image to a predetermined format at step S14 (step S14).

After that, the control unit 10 performs processing of step S15 (step S15).

In a case of the setting example of FIG. 12, when the number of the image files related to the reserved job exceeds 5, the file format of the image is changed to the PDF and the image files are saved as one PDF file.

On the other hand, when the number of the image files related to the reserved job does not exceed the predetermined upper limit of the number of saved files in the determination of step S13 (when No is given in the determination of step S13), the control unit 10 performs the processing of step S15 (step S15).

In this manner, when the number of files is not large, it is not particularly troublesome. Thus, when the number of files is the predetermined number or less, the job is executed as specified by the user. On the other hand, when the number of files exceeds the predetermined number, the format is automatically changed to the “format in which a plurality of images are combined into one file” that is set in advance.

Therefore, without trouble to manually change the setting by the user, link setting is able to be automatically changed to setting that is easy to use, so that an image forming apparatus that allows a receiver to easily refer to the plurality of pieces of image data and has high convenience is implemented.

### Embodiment 3

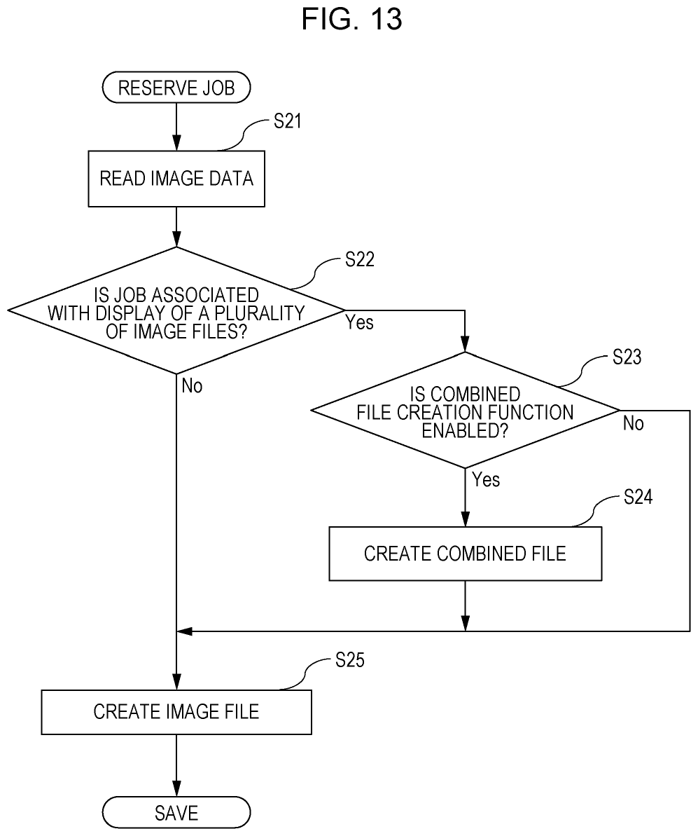

Next, job setting processing of a digital multifunction peripheral 1 according to Embodiment 3 of the disclosure will be described with reference to FIGS. 13 to 15.

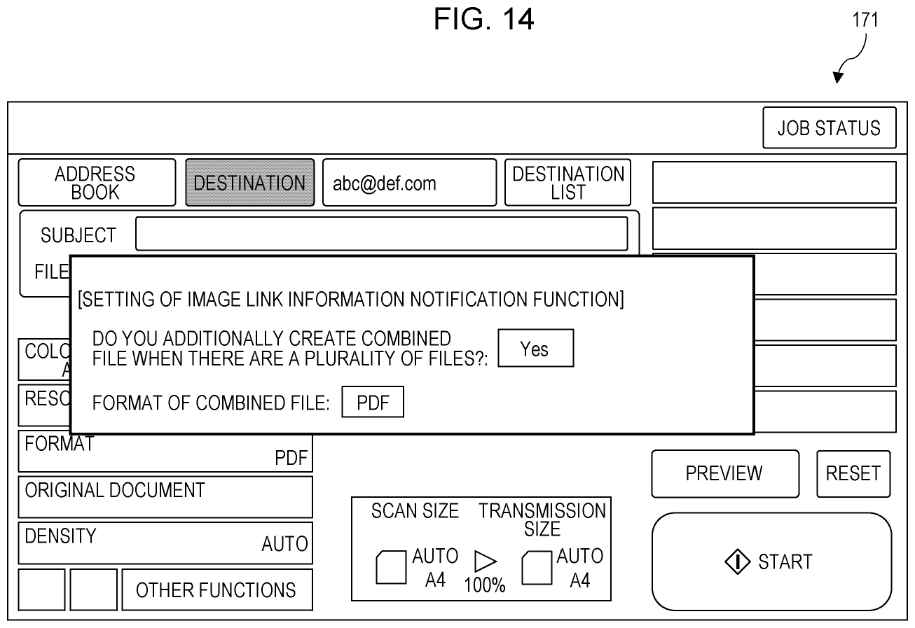

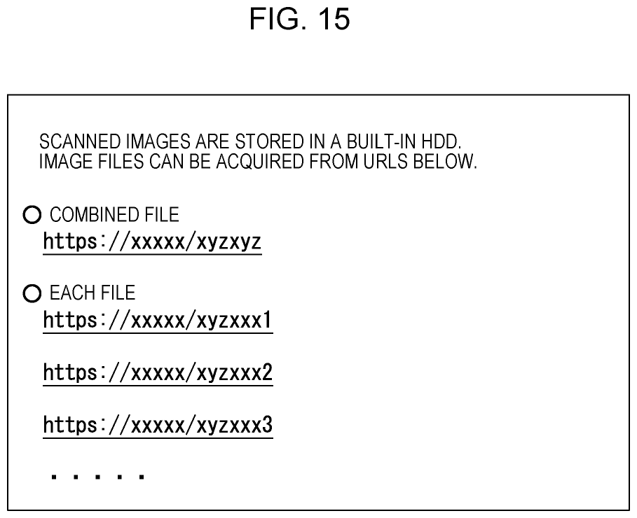

FIG. 13 is a flowchart illustrating an example of a flow of the job setting processing of the digital multifunction peripheral 1 according to Embodiment 3 of the disclosure. FIG. 14 is an explanatory view illustrating an example of a setting screen of the image link information notification function of the digital multifunction peripheral 1 illustrated in FIG. 13. FIG. 15 illustrates an example of notification of image link information by an electronic mail transmitted by the digital multifunction peripheral 1 illustrated in FIG. 13.

Note that, a schematic configuration of the digital multifunction peripheral 1 according to Embodiment 3 of the disclosure is the same as that in FIG. 2, so that description thereof will be omitted.

In FIG. 13, when the user reserves a job, the control unit 10 causes the image acquiring unit 11 to read image data related to the job reservation at step S21 (step S21).

Next, at step S22, the control unit 10 determines whether or not the reserved job is a job associated with display of a plurality of image files (step S22).

When the reserved job is a job associated with display of a plurality of image files (when Yes is given in the determination of step S22), the control unit 10 performs determination of step S23 (step S23).

On the other hand, when the reserved job is not a job associated with display of a plurality of image files (when No is given in the determination of step 122), the control unit 10 creates an image file at step S25 (step S25) and saves the created image file in the storage unit 13.

Next, at step S23, the control unit 10 determines whether or not a combined file creation function is enabled (step S23).

Specifically, as illustrated in FIG. 14, when there are a plurality of image files, the user is able to perform setting about whether or not to additionally create a combined file.

In the example of FIG. 14, “Yes” is given in the setting about whether or not to additionally create a combined file and a format of the combined file is set to the “PDF”.

When the combined file creation function is enabled in the determination of step S23 of FIG. 13 (when Yes is given in the determination of step S23), the control unit 10 creates a combined file in the predetermined format at step S24 (step S24).

After that, the control unit 10 performs the processing of step S25 (step S25).

On the other hand, when the combined file creation function is not enabled in the determination of step S23 (when No is given in the determination of step S23), the control unit 10 performs the processing of step S25 (step S25).

When the combined file is created, URLs of an image link to the combined file and image links to respective files are displayed with a message of “Scanned images are stored in a built-in HDD. Image files can be acquired from URLs below.” as illustrated in FIG. 15.

In this manner, even when the number of image files is large, it is not requested to download all the image files and it becomes easy to select and download only a desired image file, so that an image forming apparatus that allows a receiver to easily refer to the plurality of pieces of image data and has high convenience is implemented.

A desirable aspect of the disclosure also includes an aspect obtained by combining any aspects of a plurality of aspects described above.

In addition to the aforementioned embodiments, there may be various modified examples of the disclosure. Such modified examples should not be interpreted to be out of the scope of the disclosure. The disclosure should encompass meanings equivalent to the scope of the claims and all the modifications within the scope.

The present disclosure contains subject matter related to that disclosed in Japanese Priority Patent Application JP 2018-096349 filed in the Japan Patent Office on May 18, 2018, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An image processing apparatus comprising:
an image data acquiring unit that acquires image data from outside;
an operation unit that receives a transmission instruction indicating that an electronic mail including address information which allows access to the image data acquired by the image data acquiring unit is to be transmitted to an external device;
an integrated image data generation unit that, in a case where the image data acquiring unit acquires a plurality of pieces of image data and the operation unit receives the transmission instruction for the plurality of pieces of image data, when an integration condition that is predetermined is satisfied, generates integrated image data in which the plurality of pieces of image data are combined into one file and saves the integrated image data in a predetermined location; and
a communication unit that transmits, to the external device, an electronic mail including address information which allows access to the integrated image data.

2. The image processing apparatus according to claim 1, further comprising
a display unit that, in a case where the image data acquiring unit acquires a plurality of pieces of image data and the operation unit receives a transmission instruction indicating that an electronic mail including address information which allows access to the plurality of pieces of image data is to be transmitted to an external device, displays a message to inquire of a user whether or not to generate the integrated image data in which the plurality of pieces of image data are combined into one file, wherein
in a case where the operation unit receives an instruction indicating that the integrated image data is to be generated, the integrated image data generation unit generates the integrated image data and saves the integrated image data in the location, and
the communication unit transmits, to the external device, the electronic mail including address information which allows access to the integrated image data.

3. The image processing apparatus according to claim 1, further comprising
a determination unit that, in a case where the image data acquiring unit acquires a plurality of pieces of image data and the operation unit receives a transmission instruction indicating that an electronic mail including address information which allows access to the plurality of pieces of image data is to be transmitted to an external device, determines whether or not the number of the plurality of pieces of image data is greater than an upper limit number that is predetermined, wherein
in a case where the determination unit determines that the number of the plurality of pieces of image data is greater than the upper limit number, the integrated image data generation unit generates the integrated image data and saves the integrated image data in the location, and
the communication unit transmits, to the external device, the electronic mail including address information which allows access to the integrated image data.

4. The image processing apparatus according to claim 1, further comprising
a setting unit that allows a user to set whether or not to enable setting by which the integrated image data in which the plurality of pieces of image data are combined into one file is to be generated, wherein
in a case where the image data acquiring unit acquires a plurality of pieces of image data and the operation unit receives a transmission instruction indicating that an electronic mail including address information which allows access to the plurality of pieces of image data is to be transmitted to an external device, the setting of the setting unit is checked,
in a case where the setting by which the integrated image data in which the plurality of pieces of image data are combined into one file is to be generated is enabled, the integrated image data generation unit generates the integrated image data and saves the integrated image data in the location, and
the communication unit transmits, to the external device, the electronic mail including address information which allows access to the integrated image data.

5. The image processing apparatus according to claim 1, wherein
in a case of generating the integrated image data, the integrated image data generation unit saves the plurality of pieces of image data and the integrated image data in the location, and
the communication unit transmits, to the external device, an electronic mail including address information which allows access to the plurality of pieces of image data and the integrated image data.

6. An image forming apparatus comprising:
the image processing apparatus according to claim 1; and
an image forming unit that forms an image based on image data processed by the image processing apparatus.

7. An image processing method comprising:
acquiring image data from outside;
receiving a transmission instruction indicating that an electronic mail including address information which allows access to the image data acquired in the acquiring is to be transmitted to an external device;
generating, in a case where a plurality of pieces of image data are acquired in the acquiring and the transmission instruction for the plurality of pieces of image data is received in the receiving, when an integration condition that is predetermined is satisfied, integrated image data in which the plurality of pieces of image data are combined into one file and saving the integrated image data in a predetermined location; and
transmitting, to the external device, an electronic mail including address information which allows access to the integrated image data.

8. A storage medium storing an image processing program causing a processor of an image processing apparatus to execute:
acquiring image data from outside;
receiving a transmission instruction indicating that an electronic mail including address information which allows access to the image data acquired in the acquiring is to be transmitted to an external device;
generating, in a case where a plurality of pieces of image data are acquired in the acquiring and the transmission instruction for the plurality of pieces of image data is received in the receiving, when an integration condition that is predetermined is satisfied, integrated image data in which the plurality of pieces of image data are combined into one file and saving the integrated image data in a predetermined location; and
transmitting, to the external device, an electronic mail including address information which allows access to the integrated image data.
